(19) United States
(12) Patent Application Publication
(10) Pub. No.: US 2008/0209085 A1
(43) Pub. Date: Aug. 28, 2008

(54) SEMICONDUCTOR DEVICE AND DMA TRANSFER METHOD

(75) Inventor: Norifumi Fukawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/037,109

(22) Filed: Feb. 26, 2008

(30) Foreign Application Priority Data
Feb. 27, 2007 (JP) JP2007-047917

(51) Int. Cl. G06F 13/28

(52) U.S. Cl. 710/22

(57) ABSTRACT

A semiconductor device includes a plurality of resources for performing DMA transfer and a DMA controller, wherein the plurality of resources each include a transfer setting register

### CROSS-REFERENCE TO RELATED APPLICATIONS

This application is based upon and claims the benefit of priority from the prior Japanese Patent Application No. 2007-47917 filed on Feb. 27, 2007, the entire contents of which are incorporated herein by reference.

### BACKGROUND OF THE INVENTION

1. Field of the Invention

The present invention relates to a semiconductor device and a DMA transfer method in the semiconductor device.

2. Description of the Related Art

Conventionally, the maximum number of channels which can perform a DMA transfer in a descriptor type direct memory access (DMA) transfer system is previously determined. Channel transfer setting data corresponding to the resource is read out to a DMA transfer setting register when a DMA transfer request is issued from a resource, and a DMA transfer is performed.

FIG. 1 is a block diagram showing a configuration of a semiconductor device having a conventional descriptor type DMA transfer system. In the semiconductor device 100 shown in FIG. 1, transfer setting data is stored in a rewritable memory (in this case, a RAM 116 for descriptor) in a DMA controller 110. The transfer setting data corresponds to the maximum number of channels (in this case, 16 channels) capable of performing a DMA transfer. Transfer setting data of a predetermined channel (for example, a channel 1) corresponding to a resource (for example, a resource 120) is written in a DMA transfer setting register 112 when the resource requests a DMA transfer. The DMA controller 110 performs the DMA transfer using the DMA transfer setting register 112.

Japanese Patent Application Laid-Open No. 2005-222469 discloses that when received data has a data size in a first range, the received data is DMA transferred to a storage destination address. The storage destination address is read out from a first descriptor list and has a small storage capacity. The received data is stored at the storage destination address in a DMA transfer control system in order to effectively use a storage unit in a simple configuration. Japanese Patent Application Laid-Open No. 2005-222469 also discloses that when the received data has a data size of a second range which is larger than the data size of the first range, the received data is DMA transferred to a storage destination address which is read out from a second descriptor list and has a large storage capacity, and stored therein.

### SUMMARY OF THE INVENTION

According to an aspect of the invention, a semiconductor device includes a plurality of resources for performing a DMA transfer and a DMA controller, wherein the plurality of resources each have a transfer setting register.

The above-described embodiments of the present invention are intended as examples, and all embodiments of the present invention are not limited to including the features described above.

### BRIEF DESCRIPTION OF THE DRAWINGS

FIG. 1 is a block diagram showing a configuration of a semiconductor device having a conventional DMA transfer system;

FIG. 2 is a block diagram showing a configuration of a semiconductor device having a DMA transfer system according to an embodiment;

FIG. 3 is a block diagram showing a configuration of a semiconductor device having a DMA transfer system according to another embodiment;

FIG. 4 is a block diagram showing a configuration of a decoder according to an embodiment; and

FIG. 5 is a flowchart showing an operation of the DMA transfer system according to the embodiment.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

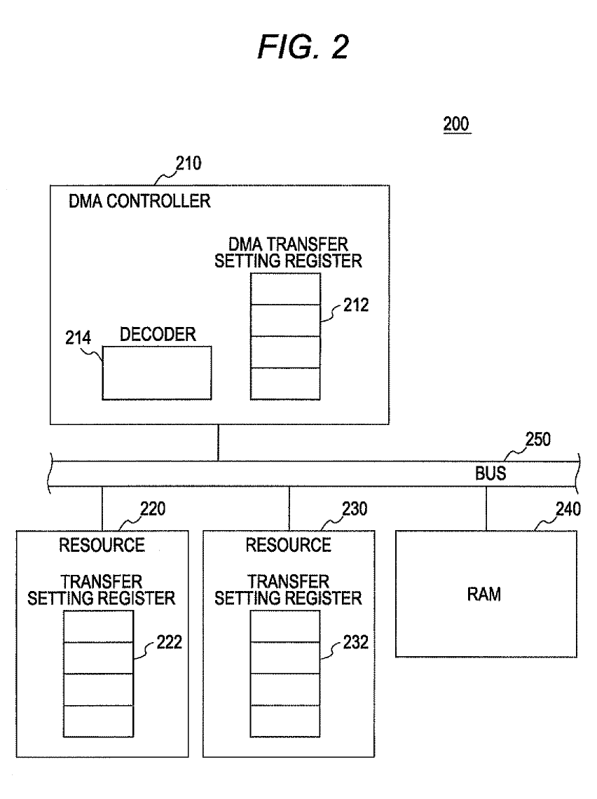

FIG. 2 is a block diagram showing a configuration of a semiconductor device including a DMA transfer control system according to an embodiment of the present invention. The semiconductor device 200 shown in FIG. 2 is, for example, a so-called Large Scale Integrated (LSI) system. The semiconductor device 200has a DMA controller 210, resources 220, 230, and a RAM 240. These components are connected through a bus 250 so that they can mutually communicate with one another.

The DMA controller 210 has a DMA transfer setting register 212 and a decoder 214.

The DMA transfer setting register 212 stores transfer setting data necessary for a DMA transfer between, for example, resources or between a resource and a RAM. The DMA controller 210 performs a DMA transfer using the DMA transfer setting register 212. The transfer setting data includes, for example, the number of times of DMA transfer (for example, 4-byte data), a DMA transfer destination address (for example, 4-byte data), a DMA transfer source address (for example, 6-byte data), and other setting data (for example, 2-byte data).

The decoder 214 specifies the respective resources 220, 230 in response to the DMA transfer requests therefrom and creates the addresses of the transfer setting registers 222, 232 thereof.

The resources 220, 230 are, for example, a UART, a timer, an A/D converter, an external interrupt controller, a serial I/O, or an image processing macro. The resources 220, 230 have the transfer setting registers 222, 232, respectively. The transfer setting register 222 stores transfer setting data necessary to a DMA transfer between, for example, RAMs or between a resource and a RAM. The transfer setting data includes, for example, the number of times of DMA transfer (for example, 4-byte data), a DMA transfer destination address (for example, 4-byte data), a DMA transfer source address (for example, 6-byte data), and other setting data (for example, 2-byte data). The other setting data is data for setting, for example, whether or not it is necessary to change an address and setting word transfer/bit transfer. This is the same as to the transfer setting register 232.

The RAM 240 is a memory for storing data to be processed by the semiconductor device 200, and the data can be DMA transferred from the resources 220, 230 to the RAM 240 and from the RAM 240 to the resources 220, 230. Further, the RAM 240 may store a computer program for operating a CPU (not shown).

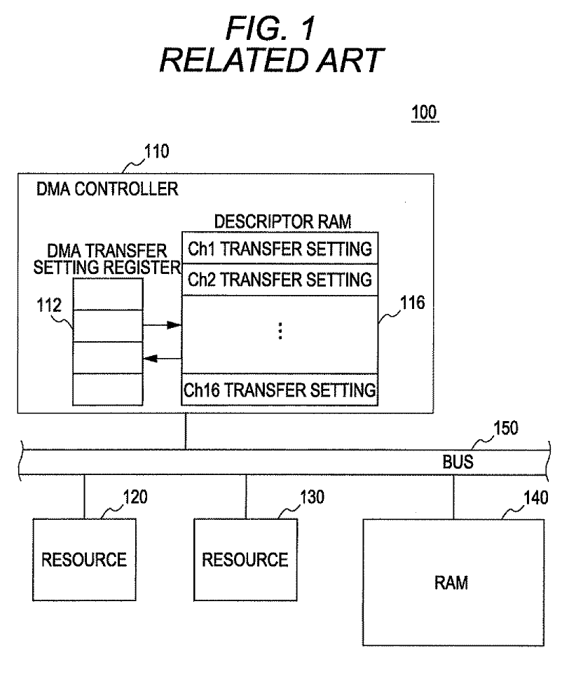

In the semiconductor device 200, the DMA controller 210 does not have a rewritable memory for storing the transfer setting data (the RAM 116 for descriptor shown in FIG. 1). The transfer setting data is stored to the transfer setting registers 222, 232 disposed to the resources 220, 230, respectively.

When, for example, the resource 220 requests a DMA transfer, the decoder 214 of the DMA controller 210 creates the address of the transfer setting register 222 of the resource 220. The transfer setting data of the transfer setting register 222 is copied to the DMA transfer setting register 212. The DMA controller 210 performs the DMA transfer using the DMA transfer setting register 212 to which the transfer setting data has been copied from the transfer setting register 222 of the resource 220.

The DMA transfer setting register is a register used when the DMA controller 210 performs the DMA transfer, and the contents thereof (for example, a transfer source address and a transfer destination address) are sequentially rewritten as the DMA transfer progresses. On the other hand, the transfer setting registers of the resources are registers for storing transfer setting data necessary to start the DMA transfer and the contents thereof are not rewritten as the DMA transfer progresses.

As described above, the DMA controller has no rewritable memory disposed therein for storing the transfer setting data corresponding to the number of channels, and a transfer setting register is disposed in each of the resources which can issue a DMA transfer request. Further, a decoder is disposed in the DMA controller to determine from which resource a DMA transfer request is issued and to create the address of the transfer setting register of the resource. With this configuration, in the semiconductor device according to the embodiment, the respective resources, which can issue the DMA request, have the transfer setting registers. Thus, the number of channels is not restricted by the DMA controller, whereby the number of resources which can perform the DMA transfer is not restricted.

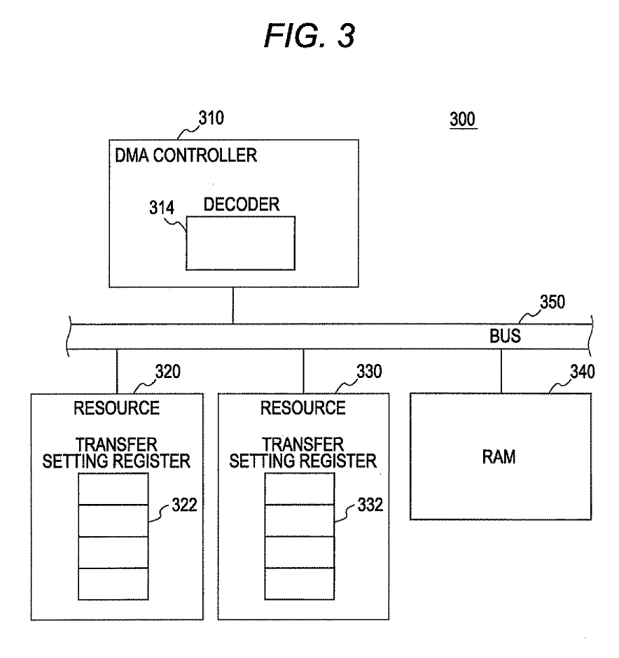

FIG. 3 is a block diagram showing a configuration of a semiconductor device having a DMA transfer system according to another embodiment. The semiconductor device 300 shown in FIG. 3 is different from the semiconductor device 200 shown in FIG. 2 in that a DMA controller 310 has no DMA transfer setting register, and transfer setting registers 322, 332 of respective resources 320, 330 also act as DMA transfer setting registers.

The DMA controller 310, for example, performs the DMA transfer by using the transfer setting register 322 of the resource 320 as the DMA transfer setting register when the resource 320 requests a DMA transfer. In this case, the DMA controller 310 sequentially rewrites the contents (for example, a transfer source address and a transfer source address) of the transfer setting register 322 of the resource 320 as the DMA transfer progresses. Time overhead is increased since the transfer setting register 322 used as the DMA transfer setting register is rewritten through a bus 350. The configuration, however, can be employed, for example, when the number of times of transfer is small, when a transfer destination address and a transfer source address do not change, and when the DMA controller 310 is disposed near to the resource 320 through a bus, since the DMA controller need not be provided with a DMA transfer setting register.

As described above, since no DMA transfer setting register is disposed in the DMA controller and the DMA transfer setting register of the resource which requests a DMA transfer is used as the DMA transfer setting register, the DMA controller can be reduced in size by omitting the transfer setting register in the DMA.

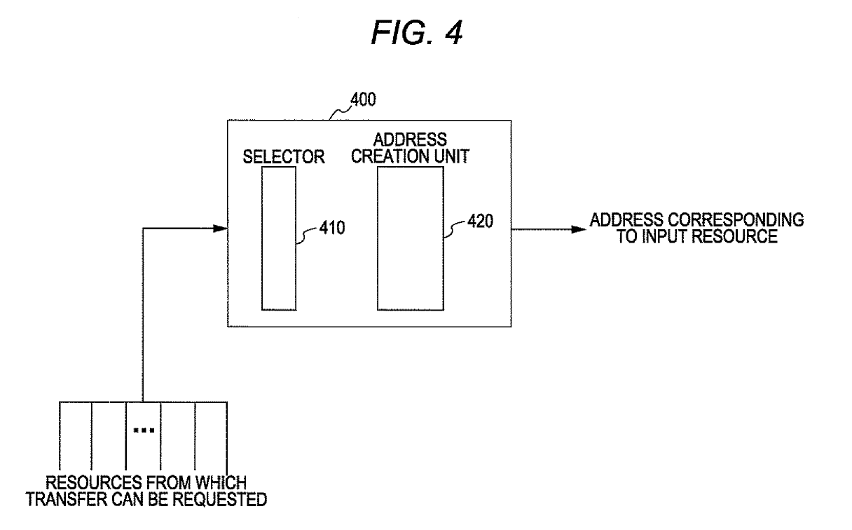

FIG. 4 is a block diagram showing a configuration of a decoder according to an embodiment. The decoder 400 shown in FIG. 4 corresponds to the decoders 214, 314 shown in FIGS. 2, 3 and includes a selector 410 and an address creation unit 420. When a DMA transfer request is issued from any of a plurality of resources, the selector 410 causes the address creation unit 420 to create an address corresponding to the resource.

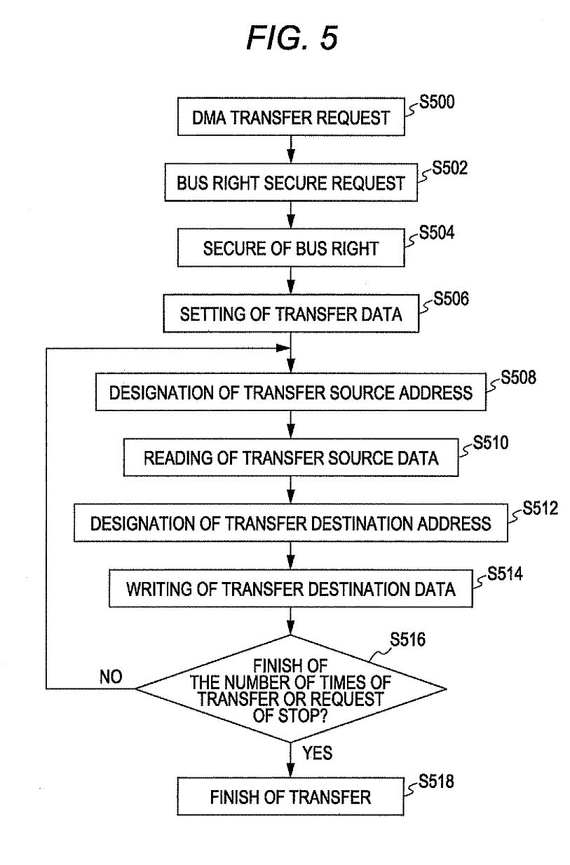

FIG. 5 is a flowchart showing an operation of the DMA transfer system according to the embodiment. A DMA controller (for example, the DMA controller 210 in FIG. 2) receives a DMA transfer request from a resource (for example, the resource 220 in FIG. 2) (operation S500). The DMA controller issues a bus right securing request to a CPU in response to the request to use a data bus (for example, the bus 250 in FIG. 2) to the DMA transfer (operation S502) and secures the bus right (operation S504). Further, the DMA controller creates an address corresponding to the resource which issues the DMA request by a decoder (for example, the decoder 214 in FIG. 2), reads out transfer setting data from a transfer setting register (in this case, the transfer setting register 222 in FIG. 2) based on the address, and stores it to a DMA transfer setting register (in this case, the DMA transfer setting register 212 in FIG. 2). The DMA controller completes preparation for performing the DMA transfer requested from the resource by performing the above operations.

Subsequently, the DMA controller performs the DMA transfer by the following operations. First, the DMA controller designates a transfer source address (operation 508), reads data from a transfer source (operation S510), and stores it to a buffer in the DMA controller. Then, the DMA controller designates a transfer destination address (operation 512) and writes the data stored in the buffer to the transfer destination (operation S514).

Next, the DMA controller determines whether or not the DMA transfer is finished as many times as the number of times of transfer set to the DMA transfer setting register are finished or whether or not a stop request is issued from the CPU, and the like (operation S516). When the DMA transfer as many times as the number of times of transfer is not finished and the stop request is not issued, (No at operation S516), the process returns to operation S508 and repeats the DMA transfer.

When the DMA transfer corresponding to the number of times of transfer is finished or a stop request is issued, (Yes at operation S516), the DMA transfer is finished (operation S518).

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A semiconductor device comprising:
a plurality of resources for performing DMA transfer; and
a DMA controller,
wherein the plurality of resources each include a transfer setting register.

2. The semiconductor device according to claim 1,
wherein the DMA controller includes a decoder for creating an address of the transfer setting register of a resource in response to the resource which requests a DMA transfer.

3. The semiconductor device according to claim 2,
wherein the DMA controller includes a DMA transfer setting register for storing data read out from the transfer setting register of the resource which requests the DMA transfer and performing the DMA transfer.

4. The semiconductor device according to claim 2,
wherein the DMA controller performs the DMA transfer using the transfer setting registers of the plurality of resources as DMA transfer setting registers.

5. The semiconductor device according to claim 2,
wherein the decoder creates addresses corresponding to the plurality of resources.

6. The semiconductor device according to claim 1,
wherein the DMA controller includes a DMA transfer setting register for storing data read out from the transfer setting register of the resource which requests the DMA transfer and performing the DMA transfer.

7. The semiconductor device according to claim 1,
wherein the DMA controller performs the DMA transfer using the transfer setting registers of the plurality of resources as DMA transfer setting registers.

8. The semiconductor device according to claim 1,
wherein the plurality of resources include at least one of a UART, a timer, an A/D converter, an external interrupt control, a serial 10, and an image macro.

9. A DMA controller comprising:
a decoder for receiving a DMA transfer request from a resource and creating an address of a transfer setting register included in the resource.

10. The DMA controller according to claim 9, further comprising:
a DMA transfer setting register for storing data read out from the transfer setting register of the resource.

11. The DMA controller according to claim 9, wherein the decoder includes a selector and an address creation unit.

12. A DMA transfer control method in a semiconductor device comprising a plurality of resources for performing a DMA transfer and a DMA controller, the method comprising:
requesting a DMA transfer at one of the plurality of resources;
creating an address of a transfer setting register of the resource which requests the DMA transfer at the DMA controller; and
performing the DMA transfer based on the address created by the DMA controller at the resource which requested the DMA transfer.
